(19) United States
(12) Patent Application Publication
(10) Pub. No.: US 2007/0211497 A1
(43) Pub. Date: Sep. 13, 2007

(54) Bulb assembly with dual connecting types

(76) Inventor: Chao-Mu Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/372,018

(22) Filed: Mar. 10, 2006

(51) Int. Cl. H01R 33/00

(52) U.S. Cl. 362/657

(57) ABSTRACT

A bulb assembly includes a shell, a holder, and a bulb, wherein the bulb and the holder are received in the shell, wherein the bulb has two conductive wires passing through the holder and being folded upward outsides. The shell is provided with a central plate extending to the bottom of the holder and separating two conductive wires from each other. Hence, there are two connecting types for electrical wires with conductive pins to insert into shell and contact with various position of the conductive wires that facilitates the utilization of the products.

### BACKGROUND OF THE INVENTION

Referring to FIG. 1 to 3, a traditional bulb assembly includes a bulb (1), a holder (2), and a shell (3). The bulb (1) is received in the holder (2), and both of them are again received in the shell (3). The bulb (1) has two conductive wires (11), each of which passes through the holder (2) and then is folded upward outside the holder (2). Two electrical wires (4) connect with relating conductive pins (5) to insert into the shell (3) from its bottom end. The pin (5) is placed between outside end of the conductive wire (11) and inner face of the shell (3) to form an electrical connection.

The present invention is to provide an improved bulb assembly with dual connecting types that facilitates the application for some decorative lighting strings. Now, accompanying with drawings, the character and structure of the present invention will be disclosed as following.

### BRIEF DESCRIPTION OF THE DRAWINGS

FIG. 1 is a perspective view showing a normal bulb assembly.

FIG. 2 is an exploded perspective view showing a traditional bulb assembly.

FIG. 3 is a cross-sectional plan view of FIG. 1.

FIG. 4 is an exploded perspective view showing a bulb assembly in a certain connecting type according to the present invention.

FIG. 5 is a cross-sectional plan view of FIG. 4.

FIG. 6 is an exploded perspective view showing a bulb assembly in another connecting type according to the present invention.

FIG. 7 is a cross-sectional plan view of FIG. 6.

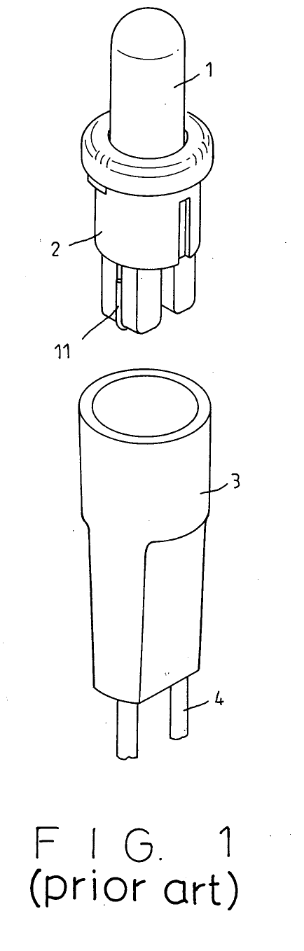

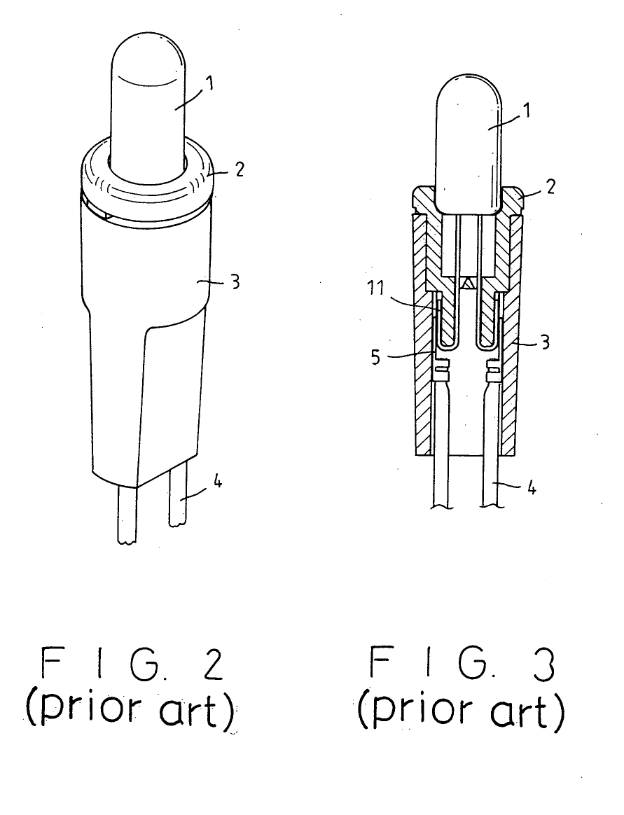

### DETAILED DESCRIPTION OF THE PREFERRED EMBODIMENT

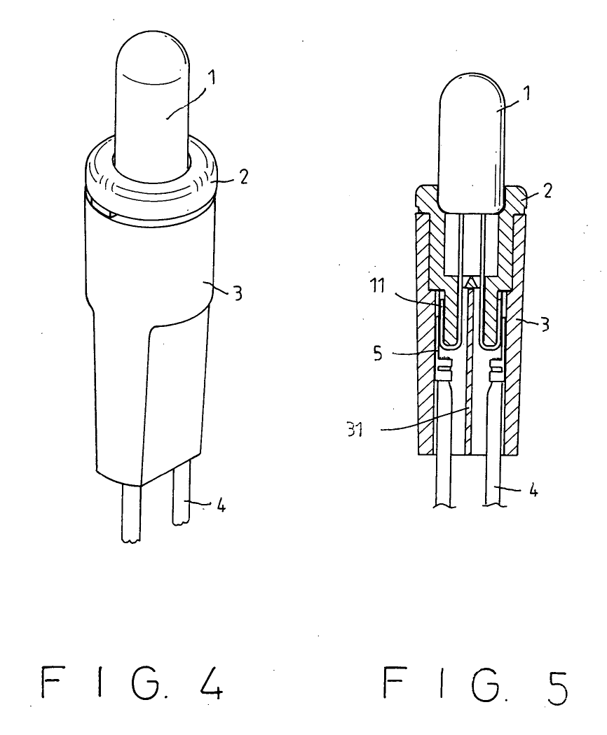

Please refer to FIGS. 4 and 5 first; the present invention includes a shell (3), a holder (2), and a bulb (1), wherein the bulb (1) has two conductive wires (11) passing through the holder (2) and being folded upward outsides. The characteristic of the present invention is that the shell (3) is provided with a central plate (31) extending to the bottom of the holder (2) that separates two conductive wires (11) from each other. As in usual, two electrical wires (4) with relating conductive pins (5) are inserting into the shell (3) and contacting with outer ends of the conductive wires (11) respectively.

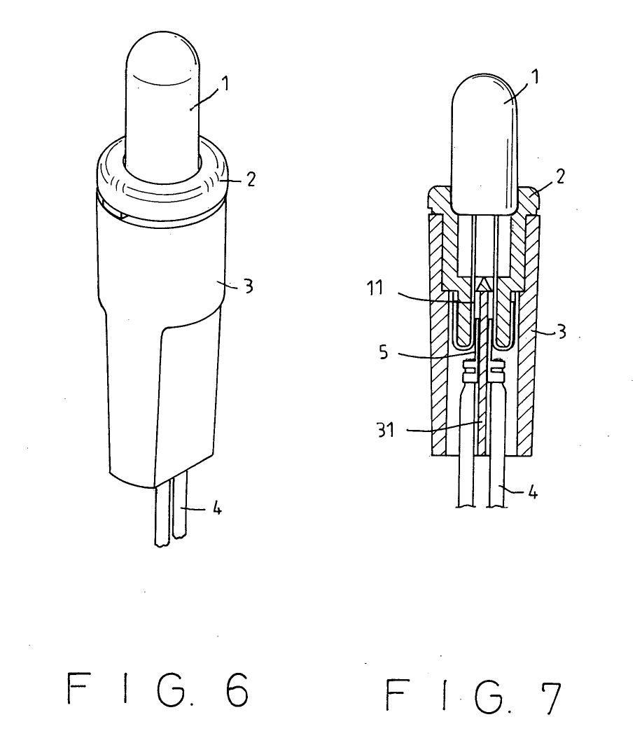

Referring to FIGS. 6 and 7, the bulb assembly of the invention can be applied in another way. In this application, the pin (5) of the electrical wire (4) is inserted into the shell (2) alone the central plate (31) and contacts with middle portion of the conductive wire (11). Hence, the distance between two electrical wires (4) is small than the former application.

Accordingly, the present invention can provide two connecting types for facilitating the utilization of user that, therefore, makes improvement and effects and should be allowed for a patent.

1. A bulb assembly for adaptive coupling to multiple connecting configurations comprising:
a shell, a holder, and a bulb, the bulb having two conductive wires passing through the holder and being folded upward and outsides about a pair of spaced bottom projections thereof;
the shell being provided with a central plate extending to the bottom of the holder between the bottom projections, the central plate separating two conductive wires from each other, and conductive pins of electrical wires being selectively inserted into the shell either between outer ends of the conductive wires and an inner face of the shell or between middle portions of the conductive wires and the central plate.

2. A bulb assembly for adaptive coupling to multiple connecting configurations comprising:
a shell;
a holder having a pair of spaced bottom projections;
a bulb having a pair of conductive wires passing through the holder, each of the conductive wires including a middle portion extending downward from the bulb along one of the bottom projections of the holder and an outer end portion extending outwardly and upward about the bottom projection; and,
a central plate extending between the bottom projections of the holder and separating the middle portions of the two conductive wires from each other;
whereby conductive pins of electrical wires are selectively captured within the shell either between the outer end portions of the conductive wires and an inner face of the shell or between the middle portions of the conductive wires and the central plate.
